(19) United States
(12) Patent Application Publication
(10) Pub. No.: US 2018/0121589 A1
(43) Pub. Date: May 3, 2018

(54) DEVICE DESIGN SUPPORT METHOD AND DEVICE DESIGN SUPPORT APPARATUS

(71) Applicant: HITACHI, LTD., Tokyo (JP)

(72) Inventors: Tetsufumi KAWAMURA, Tokyo (JP); Nobuyuki SUGII, Tokyo (JP); Yuudai KAMADA, Tokyo (JP); Yuhua ZHANG, Tokyo (JP); Atsushi ISOBE, Tokyo (JP); Ryohei MATSUI, Tokyo (JP); Daisuke RYUZAKI, Tokyo (JP)

(21) Appl. No.: 15/788,303

(22) Filed: Oct. 19, 2017

(30) Foreign Application Priority Data
Oct. 28, 2016 (JP) 2016-212036

(51) Int. Cl. G06F 17/50

(52) U.S. Cl. CPC G06F 17/5045; G06F 2217/02

(57) ABSTRACT

The present invention provides a technique for determining the circuit configuration and device structure that meet required specifications in a short time. A device design support method includes: a step (S2) of receiving an input of specifications of a sensor, and extracting the circuit configuration and device specification range corresponding to the received specifications of the sensor, by referring to a circuit design database in which the circuit configuration configuring the sensor, the range of the specifications of the device configuring the sensor, and the specifications of the sensor are associated with each other; and a step (S3) of extracting the device structure corresponding to the extracted device specification range by referring to a device design database in which the specifications of the device and the structure of the device are associated with each other.

### TECHNICAL FIELD

The present invention relates to a device design support method and a device design support apparatus.

### BACKGROUND ART

Patent Literature 1 discloses a technique for extracting circuit configurations capable of meeting the required specifications from a circuit configuration data storage unit that stores data of circuit configurations, to perform a circuit simulation on each extracted circuit configuration by changing the value of each design variable of the circuit configuration to satisfy the constraint conditions of the particular circuit configuration.

### CITATION LIST

### Patent Literature

Patent Literature 1: Japanese Unexamined Patent Application Publication No. 2010-102681

### SUMMARY OF INVENTION

### Technical Problem

The technique described in Patent Literature 1 only extracts the circuit configuration that meets required specifications, and does not take into account extraction of the device structure that meets the required specifications.

An object of the present invention is to provide a technique for determining the circuit configuration and device structure that meet the required specifications in a short time.

The above and other objects and novel features of the present invention will be apparent from the description of the present specification and the accompanying drawings.

### Solution to Problem

Of the inventions disclosed in the present application, typical ones will be briefly described below.

A device design support method in an embodiment includes: a step of receiving an input of specifications of a sensor, and extracting the circuit configuration and device specification range corresponding to the received specifications of the sensor, by referring to a circuit design database in which the circuit configuration configuring the sensor, the range of the specifications of the device configuring the sensor, and the specifications of the sensor are associated with each other; and a step of extracting the device structure corresponding to the extracted device specification range by referring to a device design database in which the specifications of the device and the structure of the device are associated with each other.

Another device design support method in an embodiment includes a step of receiving an input of specifications of a sensor, and extracting the circuit configuration and device structure corresponding to the received specifications of the sensor, by referring to an integrated design database that is generated by combining a circuit design database in which the circuit configuration configuring the sensor, the range of the specifications of the device configuring the sensor, and the specifications of the sensor are associated with each other, with a device design database in which the specifications of the device and the structure of the device are associated with each other.

A device design support apparatus in an embodiment includes: a circuit design database in which the circuit configuration configuring a sensor, the range of the specifications of the device configuring the sensor, and the specifications of the sensor are associated with each other; a device design database in which the specifications of the device and the structure of the device are associated with each other; an integrated design database that is generated by combining the circuit design database with the device design database; an input unit for receiving the input of the specifications of the sensor; and an extraction unit for extracting the circuit configuration and device structure corresponding to the input sensor specifications received by the input unit, by referring to the integrated design database.

### Advantageous Effects of Invention

The effects obtained by the typical ones of the inventions disclosed in the present application will be briefly described below.

According to an embodiment, it is possible to determine the circuit configuration and device structure that meet the required specifications in a short time.

### BRIEF DESCRIPTION OF DRAWINGS

FIG. 1 is a configuration diagram showing an example of the hardware configuration of a device design support apparatus according to an embodiment.

FIG. 2 is a configuration diagram showing an example of the software configuration of the device design support apparatus according to an embodiment.

FIG. 3 is a flow chart showing a first example of the procedure of a device design support method according to an embodiment.

FIG. 4 is a flow chart showing a second example of the procedure of the device design support method according to an embodiment.

FIG. 5 is a flow chart showing the procedure of generating the integrated design database in FIG. 4.

FIG. 6 is a schematic diagram showing an example of the device design database according to an embodiment.

FIG. 7 is a schematic diagram showing an example of the circuit design database according to an embodiment.

FIG. 8 is a schematic diagram showing an example of the integrated design database according to an embodiment.

FIG. 9 is a schematic diagram showing an example of the structure of an acceleration sensor according to an embodiment.

FIG. 10 is a block diagram showing an example of the circuit configuration of the acceleration sensor according to an embodiment.

FIG. 11 is a schematic diagram showing an example of the designer input information in an input/output interface according to an embodiment.

FIG. 12 is a schematic diagram showing an example of the extracted information in the input/output interface according to an embodiment.

### DESCRIPTION OF EMBODIMENTS

In all the drawings for describing the embodiment below, the same components are, in principle, denoted by the same reference numerals and the repetitive description thereof will be omitted. Note that hatching may be used even in plan view and may be omitted even in cross section to make the figure easy to understand.

Hereinafter, an embodiment of the present invention will be described in detail with reference to the accompanying drawings. First, to make the features of the embodiment more understandable, the room for improvement existing in the related art will be described.

### [Room for Improvement]

Various sensors are required in the era of IoT (Internet of Things). However, the design of sensors such as MEMS (Micro Electro Mechanical Systems) includes designs of various layers, such as device structure and circuit configuration, which are highly independent of each other. The approximation of these designs of various layers is cumbersome and takes time. This makes it difficult to develop various kinds of products.

In the method for designing a sensor in the related art, the device specifications are first determined from the sensor specifications. Next, device design (material and structure determination) is performed. Further, processes such as circuit design are performed. Then, these processes are repeated until the outputs meet the sensor specifications.

In the design method of a sensor in the related art, the designer has performed all the processes described above by repeating a calculation by Newton's method using a calculation tool, based on the experience and intuition. For this reason, the designer has experienced many trials and errors and has taken a lot of time to determine the feasibility of the sensor and develop the sensor.

Further, the technique described in Patent Literature 1 only extracts the circuit configuration that meets the required sensor specifications and does not take into account the extraction of the device structure that meets the sensor specifications. One reason for this is that the design of a sensor includes designs of various layers such as device structure and circuit configuration, which are highly independent of each other, so that the design of each layer is performed in series or parallel as another operation.

Thus, the present embodiment has been devised in terms of room for improvement existing in the related art described above. Hereinafter, the technical idea in the present embodiment in which the improvement is applied will be described with reference to the drawings. The technical idea in the present embodiment is to provide a technique for determining the circuit configuration and device structure that meet the required sensor specifications.

### Embodiment

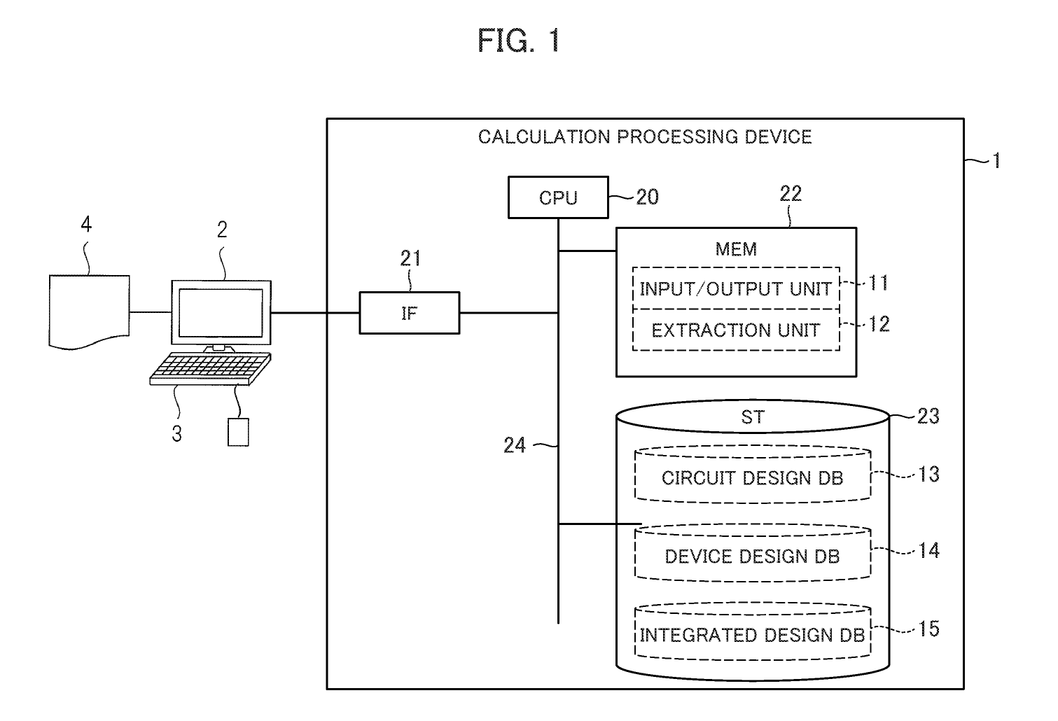

The device design support apparatus and device design support method according to the present embodiment will be described with reference to FIGS. 1 to 12.

In the present embodiment, an acceleration sensor of a MEMS device is described as an example of the device. However, the present invention can also be applied to other devices and other sensors.

### <Device Design Support Apparatus>

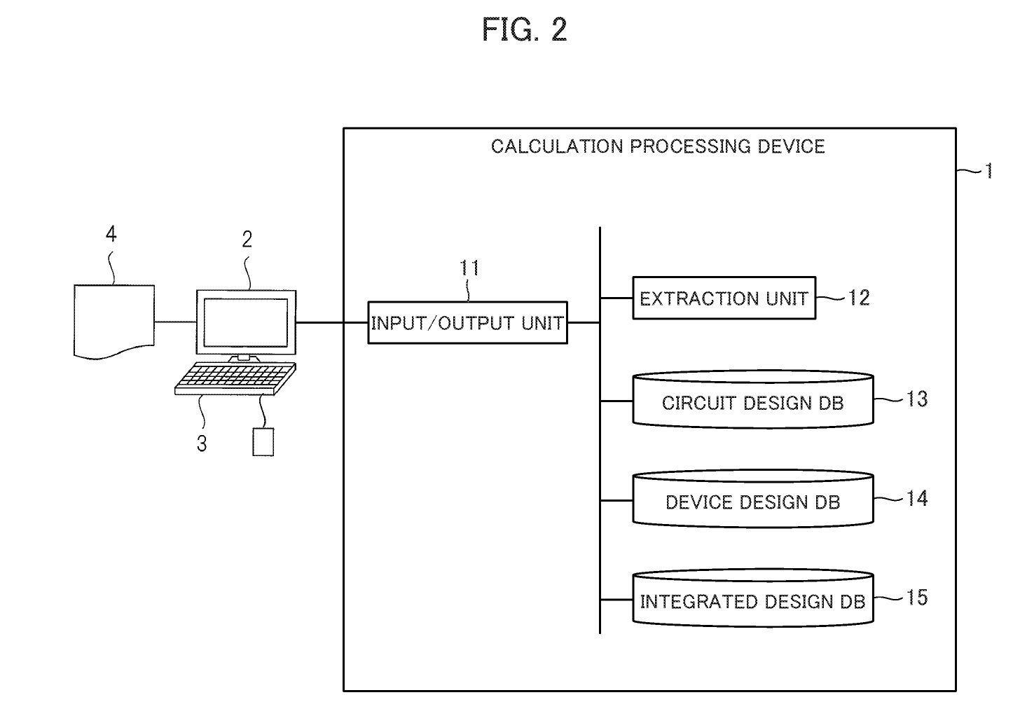

The device design support apparatus according to the present embodiment will be described with reference to FIGS. 1 to 2. FIG. 1 is a configuration diagram showing an example of the hardware configuration of the device design support apparatus according to the present embodiment. FIG. 2 is a configuration diagram showing an example of the software configuration of the device design support apparatus according to the present embodiment.

The device design support apparatus according to the present embodiment is a computer system with the hardware such as a calculation processing device 1, a display device 2, an input device 3, an output device 4, or the like, as shown in FIG. 1. The calculation processing device 1 includes: a central processing unit (CPU) 20; a memory (MEM) 22 provided with an input/output unit 11 and an extraction unit 12; a storage (ST) 23 which is a storage device that stores a circuit design database (DB) 13, a device design database (DB) 14, an integrated design database (DB) 15, or the like; and an input/output interface (IF) 21 or the like, in which the components are connected to each other by an internal bus 24. The display device 2 is a display or the like. The input device 3 is a keyboard and a mouse, or the like. The output device 4 is a printer or the like.

Further, the device design support apparatus is configured to be able to perform input and output with an external device. As the external device, for example, device processing equipment not shown can be used. In this case, cooperation between the device design support apparatus and the device processing equipment is possible.

The device design support apparatus configures functional parts, each of which is implemented by the software of the device design support apparatus, by executing each of the programs stored in the memory 22 on the central processing unit 20 within the calculation processing device 1. For example, each of the programs stored in the memory 22 is read from the storage 23 and stored in the memory 22 in the starting phase of the design process. At this time, different data is stored in the storage 23. Each data piece is also read from the storage 23 and stored in the memory 22 in the starting phase of the design process. Of course, in addition to reading the programs and data from the storage 23 and storing them in the memory 22, it is also possible to use each of the programs and data that have already been stored in the memory 23.

Each functional part implemented by the software of the device design support apparatus includes, as shown in FIG. 2, the input/output unit 11 and the extraction unit 12. The functional parts share the circuit design database (DB) 13, the device design database (DB) 14, and the integrated design database (DB) 15.

In the device design and circuit design, the input/output unit 11 is a functional part that functions as an input unit for receiving an input of specifications of a sensor. Further, the input/output unit 11 also functions as an output unit that outputs the circuit configuration and device structure extracted by the extraction unit 12. Further, the input/output unit 11 receives data input from a keyboard and a mouse, and performs processes such as displaying the data on the display and outputting the data to be printed to the printer. Further, although not shown, it is also possible that the input/output unit 11 receives data input from an external device through a communication line and outputs data to the external device.

In the device design and circuit design, the extraction unit 12 is a functional part that functions as an extraction unit for extracting the circuit configuration and device structure corresponding to the sensor specifications received by the input/output unit 11, by referring to the integrated design database 15. Further, the extraction unit 12 is also a functional part for extracting the circuit configuration and range of device specifications, which correspond to the sensor specifications received by the input/output unit 11, by referring to the circuit design database 13, and then extracting the device structure corresponding to the extracted range of device specifications, by referring to the device design database 14.

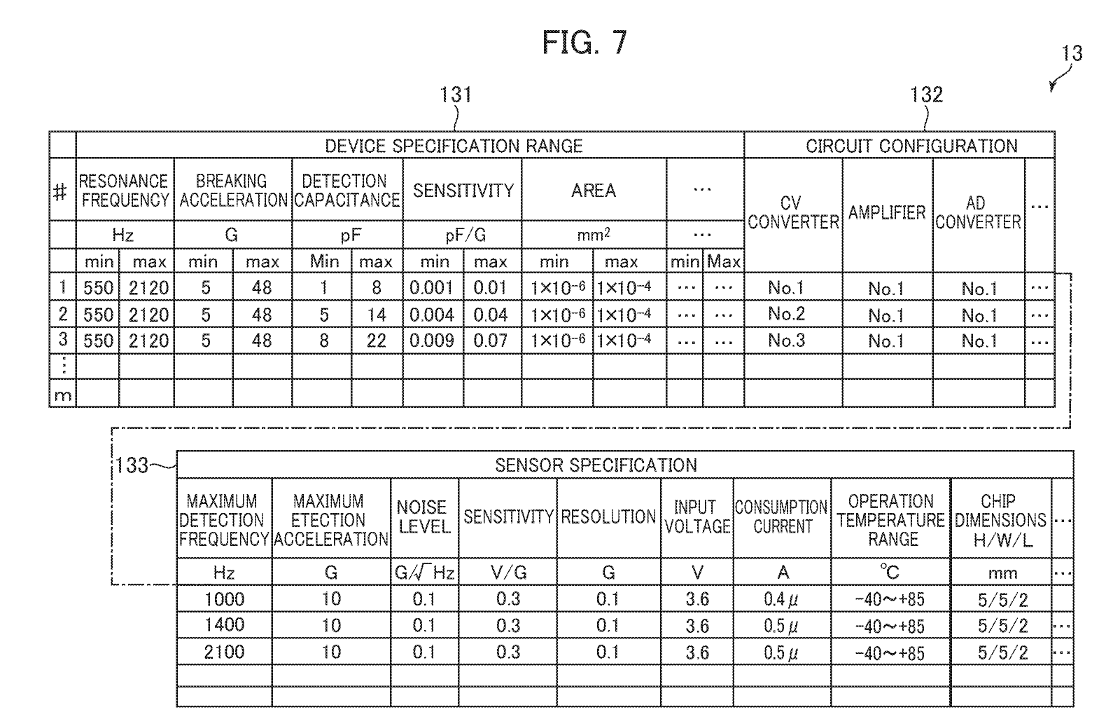

The circuit design database 13 is a database in which the circuit configuration configuring the sensor, the range of the specifications of the device configuring the sensor, and the specifications of the sensor are associated with each other. The details of the circuit design database 13 will be described below with reference to FIG. 7.

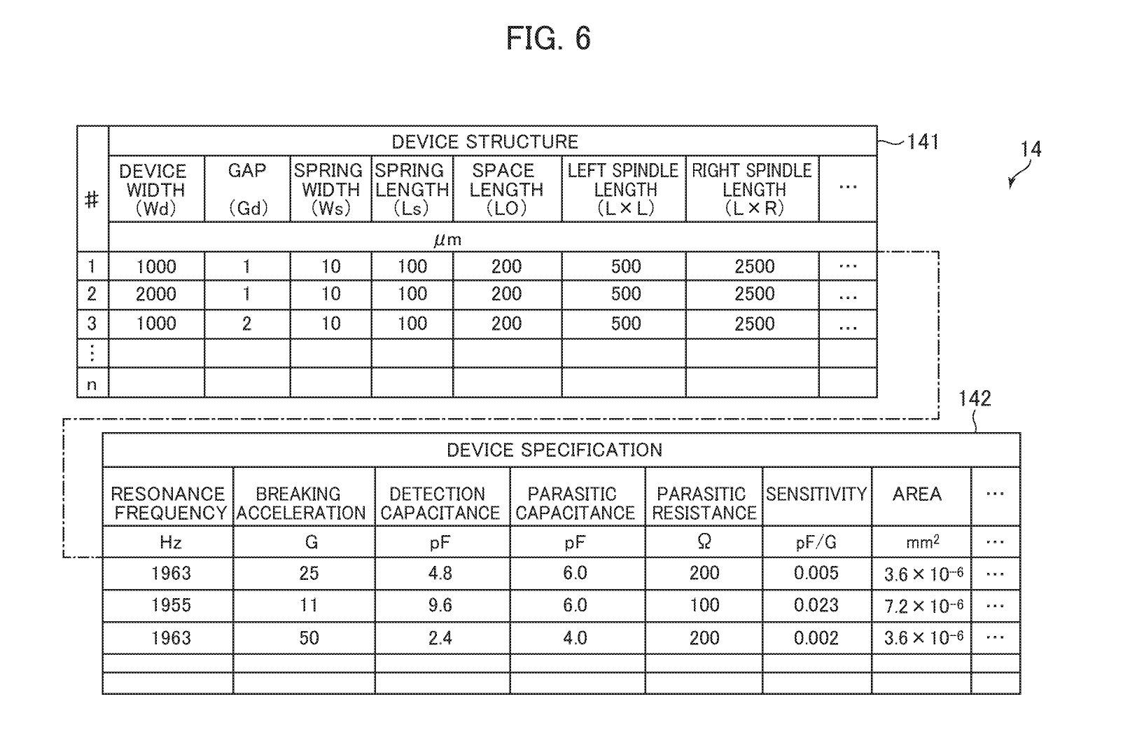

The device design database 14 is a database in which the specification of the device and the structure of the device are associated with each other. The details of the device design database 14 will be described below with reference to FIG. 6.

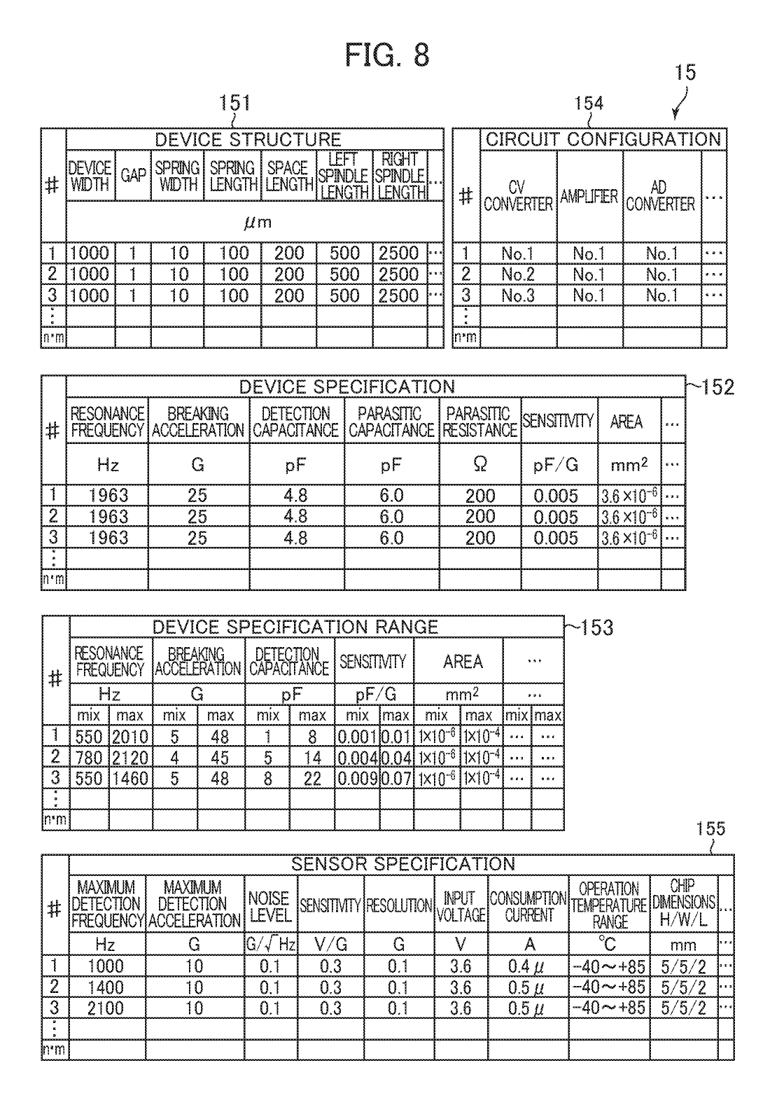

The integrated design database 15 is a database generated by combining the circuit design database 13 with the device design database 14. The details of the integrated design database 15 will be described below with reference to FIG. 8.

In particular, the databases 13, 14, and 15 are databases generated by a database builder by performing, in advance, a simulation that covers the entire possible range of production by using a computer so that the solutions are not biased by the designer's rule of thumb. It is to be noted that the database builder can be the same person as the designer who performs detailed design in the subsequent steps, or may be a person other than the designer.

### <Device Design Support Method>

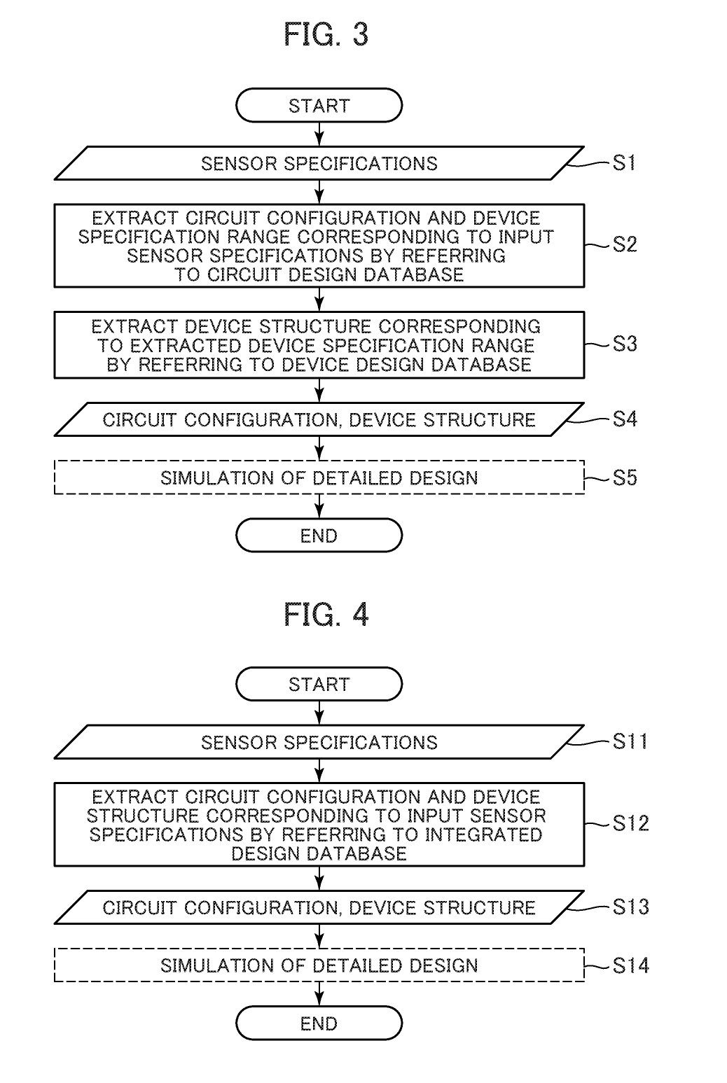

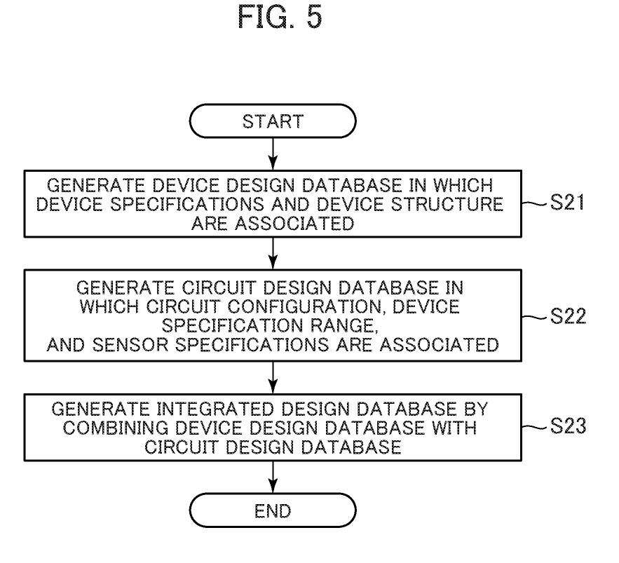

The device design support method according to the present embodiment is described with reference to FIGS. 3 to 5. FIG. 3 is a flow chart showing a first example of the procedure of the device design support method according to the present embodiment. FIG. 4 is a flow chart showing a second example of the procedure of the device design support method according to the present embodiment. FIG. 5 is a flow chart showing the procedure of generating the integrated database in FIG. 4. The device design support method according to the present embodiment is executed in the device design support apparatus described above.

### FIRST EXAMPLE

In the first example of the procedure of the device design support method according to the present embodiment, the database builder generates the circuit design database 13 and the design database 14, as prior work, by using a computer before starting the device design and circuit design.

As shown in FIG. 3, after starting the device design and circuit design, the device deign support apparatus receives an input of sensor specifications from the designer through the input/output unit 11 of the device design support apparatus (Step S1). The sensor specifications include maximum detection frequency, maximum detection acceleration, noise level, sensitivity, resolution, input voltage, consumption current, operation temperature range, chip dimensions, or the like.

Next, the extraction unit 12 of the device design support apparatus extracts the circuit configuration and the device specification range that correspond to the input sensor specifications by referring to the previously generated circuit design database 13 (Step S2). The circuit configuration includes a CV converter, an amplifier, an AD converter, or the like. The device specification range includes resonance frequency, breaking acceleration, detection capacitance, parasitic capacitance, parasitic resistance, sensitivity, area, or the like. Each device specification range has a lower limit and an upper limit.

Further, the extraction unit 12 of the device design support apparatus extracts the device structure corresponding to the device specification range extracted in Step S2, by referring to the previously generated device design database 14 (Step S3). The device structure includes device width, gap, spring width, spring length, space length, left spindle length, right spindle length, or the like.

Then, the input/output unit 11 of the device design support apparatus outputs the circuit configuration extracted in Step S2 as well as the device structure extracted in Step S3 (Step S4).

As described above, the device design support method using the previously generated circuit design database 13 and the previously generated device design database 14 is completed. For example, when the sensor specifications are input by the designer in Step S1, Steps S2 to S4 are automatically performed by the device design support apparatus as described above.

Then, with respect to the circuit configuration and the device structure that are output in Step S4, the designer performs simulation of detailed design by using the finite element method or other schemes (Step S5). Note that the simulation of detailed design can be performed by the device design support apparatus according to the present embodiment, or may be performed by an external device.

In the present embodiment, it is also possible to include the process from the input of the sensor specifications in Step S1 to the end of the simulation of detailed design in Step S5 into the procedure of the device design support method.

### SECOND EXAMPLE

In the first example of the procedure of the device design support method, the description has focused on the case of referring to the previously generated circuit design database 13 and the previously generated device design database 14. However, the following second example can also be applied. The second example will be described with reference to FIG. 4.

In the second example of the procedure of the device design support method according to the present embodiment, the database builder generates the integrated design database 15 by using a computer, as prior work, by using a computer before starting the device design and circuit design. The integrated design database 15 is generated by combining the above-described circuit design database 13 with the above-described device design database 14.

As shown in FIG. 4, after starting the device design and circuit design, the device design support apparatus first receives, similarly to the above-described first example, an input of specifications of a sensor from the designer, through the input/output unit 11 of the device design support apparatus (Step S11). The sensor specifications include, similarly to the above-described first example, maximum detection frequency, maximum detection acceleration, noise level, sensitivity, resolution, input voltage, consumption current, operation temperature range, chip dimensions, or the like.

Next, the extraction unit 12 of the device design support apparatus extracts the circuit configuration and device structure corresponding to the input sensor specifications by referring to the previously generated integrated design database 15 (Step S12). The circuit configuration includes, similarly to the above-described first example, a CV converter, an amplifier, an AD converter, or the like. The device structure includes, similarly to the above-described first example, device width, gap, spring width, spring length, left spindle length, right spindle length, or the like.

Then, the input/output unit 11 of the device design support apparatus outputs the circuit configuration and device structure extracted in Step S12 (Step S13).

As described above, the device design support method using the previously generated integrated design database 15 is completed. For example, when the sensor specifications are input by the designer in Step S11, Steps S12 to S13 are automatically performed by the device design support apparatus described above.

Then, with respect to the circuit configuration and device structure output in Step S13, the designer performs simulation of detailed design by using the finite element method or other schemes (Step S14). Note that the simulation of detailed design can be performed by the device design support apparatus according to the present embodiment, or may be performed by an external device.

In the present embodiment, it is also possible to include the process from the input of the sensor specifications in Step S11 to the end of the simulation of detailed design in Step S14 into the procedure of the device design support method.

In the second example, the generation of the integrated design database 15 is performed by the procedure shown in FIG. 5. As shown in FIG. 5, after the generation of the integrated design database 15 is started, the device design database 14 is first generated in such a way that the device specifications and the device structure are associated with each other (Step S21). The device design database 14 has, for example, n conditions.

Next, the circuit design database 13 is generated in such a way that the circuit configuration, the device specification range, and the sensor specifications are associated with each other (Step S22). The circuit design database 13 has, for example, m conditions. The circuit configuration is a circuit configuration that configures the sensor. The device specification range is the device specification range to be accepted. The sensor specifications are the sensor specifications generated by combining the device with the circuit.

Then, the integrated design database 15 is generated by combining the device design database 14 with the circuit design database 13 (Step S23). The integrated design database 15 has, for example, n×m conditions. The integrated design database 15 is the integrated design database of the device and the circuit.

In the generation of the integrated design database 15, it is designed to validate only conditions in which the device specification of the device design database 14 corresponds to the device specification range of the device in the circuit design database 13. In other words, a combination in which the device specification is included in the device specification range is automatically validated, and a combination in which the device specification is not included in the device specification range is automatically invalidated. For example, in the integrated design database 15 described below (FIG. 8), #1 is a valid combination while #2 and #3 are invalid combinations.

As described above, the generation of the integrated design database 15 is completed. For example, when generation start is instructed by the designer, Steps S21 to S23 are automatically performed by the device design support apparatus described above.

Hereinafter, a detailed description will be given of the design databases (the circuit design database 13, the device design database 14, and the integrated design database 15), and the input/output interface or the like in the first and second examples of the procedure of the device design method according to the present embodiment.

### <Design Databases>

The design databases in the present embodiment will be described with reference to FIGS. 6 to 8. FIG. 6 is a schematic diagram showing an example of the device design database in the present embodiment. FIG. 7 is a schematic diagram showing an example of the circuit design database in the present embodiment. FIG. 8 is a schematic diagram showing an example of the integrated design database in the present embodiment.

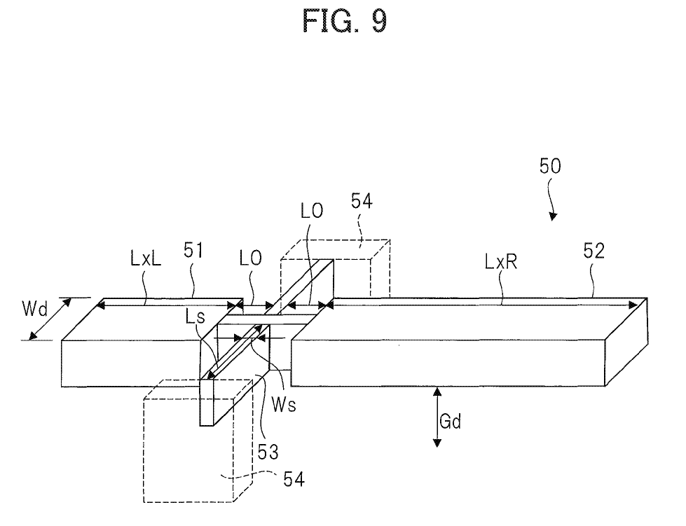

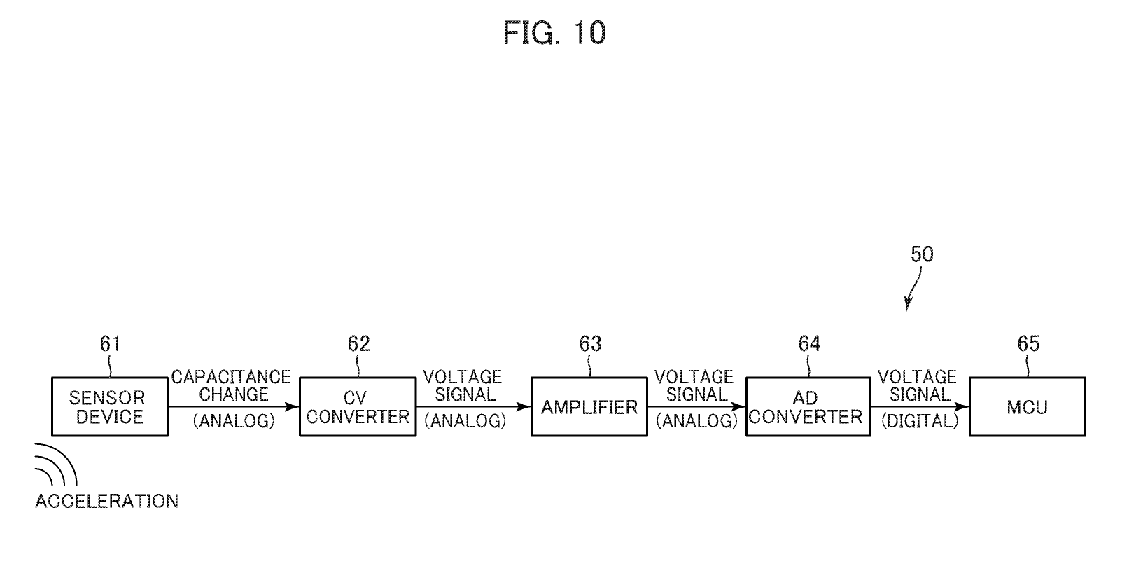

Further, FIG. 9 is a schematic diagram showing an example of the structure of the acceleration sensor in the present embodiment. FIG. 10 is a block diagram showing an example of the circuit configuration of the acceleration sensor in the present embodiment.

As shown in FIG. 9, the structure of the target acceleration sensor 50 in the present embodiment is a seesaw type device structure in which a left spindle 51 and a right spindle 52 are connected by a spring 53. The spring 53 has a cross shape in a plan view, in which the left spindle 51 and the right spindle 52 are respectively connected to the opposite ends on one side of the cross, and in which fixed parts 54 for fixing the cross-shaped spring 53 to the substrate are respectively connected to the opposite ends on the other side of the cross. In FIG. 9, Wd represents the width of the device and Gd represents the gap between the device and the electrode. Ws represents the width of the spring 53 and Ls represents the length of the spring 53. LO represents the space length between the spring 53 and the left spindle 51 as well as the space length between the spring 53 and the right spindle 52. L×L represents the length of the left spindle 51. L×R represents the length of the right spindle 52.

As shown in FIG. 10, the target acceleration sensor 50 in the present embodiment includes, as circuit configuration, a sensor device 61, a CV (Capacity to Voltage) converter 62, an amplifier 63, an AD (Analog to Digital) converter 64, an MCU (Micro Controller Unit) 65, or the like. The sensor device 61 is the device described above shown in FIG. 9, which detects the applied acceleration. The change in the capacitance of the detection signal detected by the sensor device 61 is converted to a voltage by the CV converter 62 and further amplified by the amplifier 63, and then the analog electrical signal is converted to a digital voltage signal by the AD converter 64. Then, the MCU 65 controls the circuit, or the like, connected to the subsequent stage of the MCU 65 based on the voltage signal that is converted by the AD converter 64.

With respect to the acceleration sensor 50 of the device structure (FIG. 9) and the circuit configuration (FIG. 10), the device design support apparatus includes, as the design databases, the device design database 14 shown in FIG. 6, the circuit design database 13 shown in FIG. 7, and the integrated design database 15 shown in FIG. 8.

As shown in FIG. 6, a device structure 141 and device specification 142 are associated with each other and stored in the device design database 14. The device structure 141 is the structure of the device configuring the acceleration sensor 50. The device structure 141 includes device width (Wd), gap (Gd), spring width (Ws), spring length (Ls), space length (LO), left spindle length (L×L), right spindle length (L×R), or the like. The device specification 142 shows the specifications of the device configuring the acceleration sensor 50. The device specification 142 includes resonance frequency, breaking acceleration, detection capacitance, parasitic capacitance, parasitic resistance, sensitivity, area, or the like.

As shown in FIG. 7, a device specification range 131, a circuit configuration 132, and a sensor specification 133 are associated with each other and stored in the circuit design database 13. The device specification range 131 is the range of the specifications of the device configuring the acceleration sensor 50. The device specification range 131 includes resonance frequency, breaking acceleration, detection capacitance, parasitic capacitance, parasitic resistance, sensitivity, area, or the like. Each device specification range has a lower limit (min) and an upper limit (max). The circuit configuration 132 is the configuration of the circuit configuring the acceleration sensor 50. The circuit configuration 132 includes a CV converter, an amplifier, an AD converter, or the like. The sensor specification 133 shows the specifications of the acceleration sensor 50. The sensor specification 133 includes maximum detection frequency, maximum detection acceleration, noise level, sensitivity, resolution, input voltage, consumption current, operation temperature range, chip dimensions (H (height))/W (width)/L (length)), or the like.

As shown in FIG. 8, a device structure 151, a device specification 152, a device specification range 153, a circuit configuration 154, and a sensor specification 155 are associated with each other and stored in the integrated design database 15. The device structure 151 includes the same data as the device structure 141 of the above-described device design database 14. The device specification 152 includes the same data as the device specification 142 of the above-described device design database 14. The device specification range 153 includes the same data as the device specification range 131 of the above-described circuit design database 13. The circuit configuration 154 includes the same data as the circuit configuration 132 of the above-described circuit design database 13. The sensor specification 155 includes the same data as the sensor specification 133 of the above-described circuit design database 13. In other words, the integrated design database 15 is the database that is generated by combining the above-described device design database 14 with the above-described circuit design database 13.

### <Input/Output Interface>

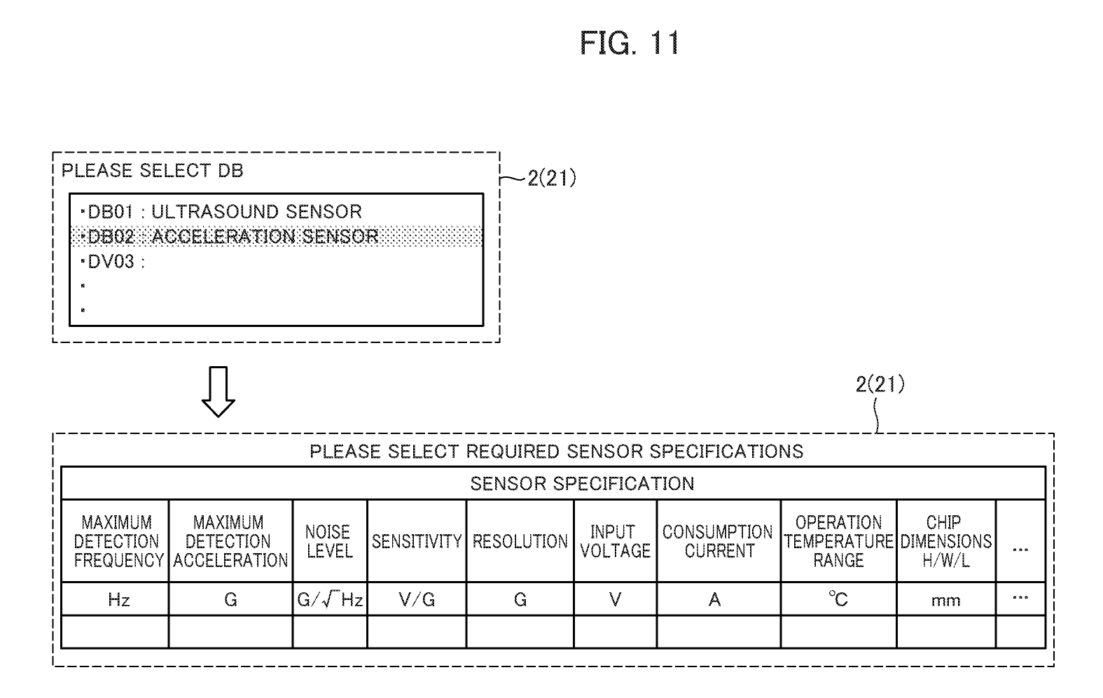

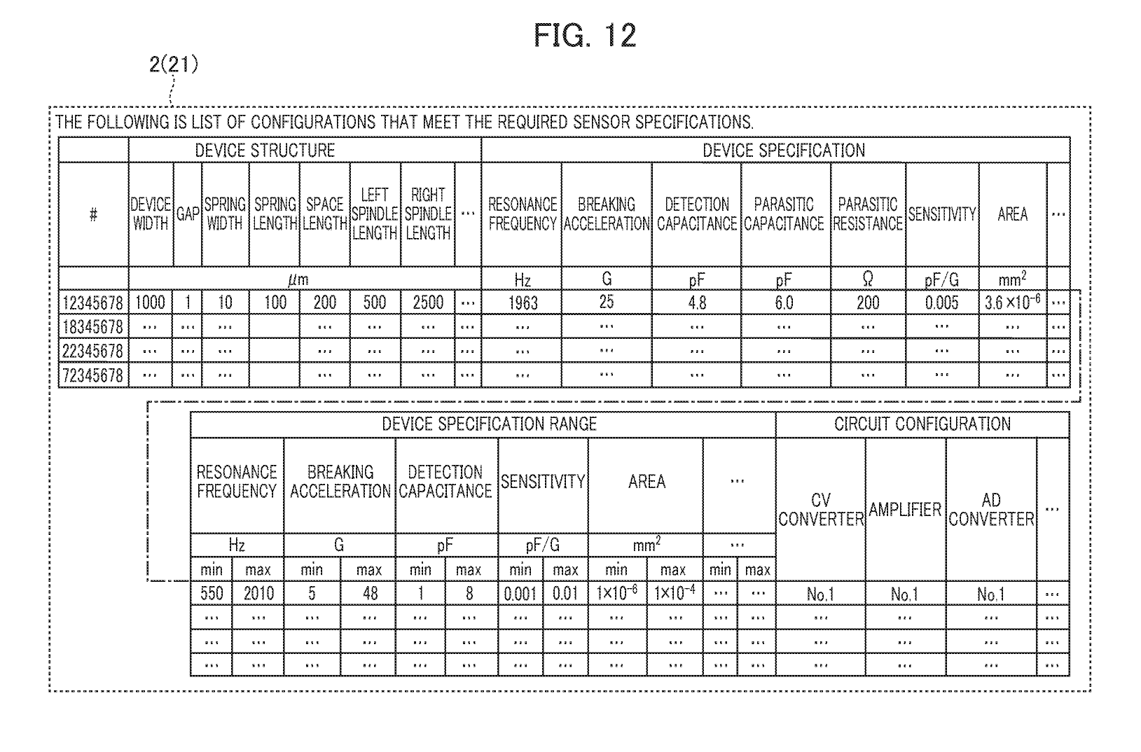

The input/output interface in the present embodiment will be described with reference to FIGS. 11 and 12. FIG. 11 is a schematic diagram showing an example of the designer input information in the input/output interface in the present embodiment. FIG. 12 is a schematic diagram showing an example of the extracted information in the input/output interface in the present embodiment.

In the procedure of the device design support method in the first example (FIG. 3) and in the second example (FIG. 4) described above, the designer input information shown in FIG. 11 is displayed on the screen of the display device 2 through the input/output interface 21 in the step of receiving an input of sensor specifications from the designer through the input/output unit 11 of the device design support apparatus (S1, S11).

As shown in FIG. 11, a screen that prompts the designer to select database (DB) is displayed as designer input information. In this selection screen, the designer selects the database of the acceleration sensor. Then, a screen that prompts the designer to input the required sensor specifications is displayed. In this input screen, the designer inputs the required sensor specifications. The designer inputs, as the sensor specifications, maximum detection frequency, maximum detection acceleration, noise level, sensitivity, resolution, input voltage, consumption current, operation temperature range, chip dimensions, or the like.

Then, the step (S2, S3, S12) of extracting the circuit configuration and device structure corresponding to the input sensor specifications is performed by the extraction unit 12 of the device design support apparatus. The extracted information shown in FIG. 12 is displayed on the screen of the display device 2 through the input/output interface 21.

As shown in FIG. 12, a list of configurations that meet the required sensor specification is displayed as the extracted information. The device structure, the device specification, the device specification range, and the circuit configuration are associated with each other in this list. This extracted information is the information extracted from the valid combinations as the conditions in which the device specifications correspond to the device specification range in the step (S23) of generating the integrated design database 15.

Based on the extracted information, the input/output unit 11 of the device design support apparatus outputs the circuit configuration and the device structure that meet the required sensor specifications in the step (S4, S13) of outputting the circuit configuration and the device structure.

For example in FIG. 12, the input/output unit 11 of the device design support apparatus outputs the following parameters as the device structure for #12345678: device width=1000 μm, gap=1 μm, spring width=10 μm, spring length=100 μm, space length=200 μm, left spindle length=500 μm, right spindle length=2500 μm, and the like. Further, the input/output unit 11 of the device design support apparatus outputs the following parameters as the circuit configuration for #12345678: CV converter=No. 1, amplifier=No. 1, AD converter=No. 1, and the like.

Then, simulation of detailed design is performed on the output circuit configuration and device structure, by using the finite element method or other schemes.

### <Advantageous Effects>

According to the device design support apparatus and the device design support method in the present embodiment, it is possible to determine the circuit configuration and the device structure that meet the required sensor specifications in a short time. In this way, it is possible to reduce the TAT (Turn Around Time) for the device design and circuit design.

More specifically, the device design support apparatus and the device design support method, it is possible to perform device design and circuit design by a series of processes by sequentially referring to the circuit design database 13 and the device design database 14. As a result, the circuit configuration and the device structure that meet the required sensor specifications can be determined in a short time, so that it is possible to reduce the TAT for the device design and circuit design.

Alternatively, in the device design support apparatus and the device design support method, it is possible to perform device design and circuit design by a batch process by referring to the integrated design database 15. As a result, the circuit configuration and the device structure that meet the required sensor specifications can be determined in a short time, so that it is possible to reduce the TAT for the device design and circuit design.

While the invention made by the present inventors has been concretely described based on the embodiment, the present invention is not limited to the above-described embodiment. It is apparent to those skilled in the art that various modifications and variations can be made without departing from the scope of the present invention.

For example, in the above-described embodiment, the MEMS device has been described as an example of a device. However, the present invention can also be applied to other devices. Further, although the acceleration sensor has been described as an example of the MEMS device, the present invention can also be applied to other sensors.

Note that the present invention is not limited to the embodiment described above but includes various variations. For example, the exemplary embodiment has been described in detail for better understanding of the present invention, and the present invention is not necessarily limited to the embodiment with all the configurations described above.

In addition, for some configurations of the embodiment, it is possible to make the addition, deletion, and substitution of other configurations.

### LIST OF REFERENCE SIGNS

1: calculation processing device
2: display device
3: input device
4: output device
11: input/output unit
12: extraction unit
13: circuit design database
14: device design database
15: integrated design database
20: central processing unit
21: input/output interface
22: memory
23: storage
24: internal bus
50: acceleration sensor
51: left spindle
52: right spindle
53: spring
54: fixed part
61: sensor device
62: CV converter
63: amplifier
64: AD converter
65: MCU

1. A device design support method comprising:
a step of receiving an input of specifications of a sensor, and extracting the circuit configuration and device specification range corresponding to the received specifications of the sensor, by referring to a circuit design database in which the circuit configuration configuring the sensor, the range of the specifications of the device configuring the sensor, and the specifications of the sensor are associated with each other; and
a step of extracting the device structure corresponding to the extracted device specification range by referring to a device design database in which the specifications of the device and the structure of the device are associated with each other.

2. The device design support method according to claim 1,
wherein the sensor is an acceleration sensor of a MEMS device.

3. A device design support method comprising a step of receiving an input of specifications of a sensor, and extracting the circuit configuration and device structure corresponding to the received specifications of the sensor, by referring to an integrated design database that is generated by combining a circuit design database in which the circuit configuration configuring the sensor, the range of the specifications of the device configuring the sensor, and the specifications of the sensor are associated with each other, with a device design database in which the specifications of the device and the structure of the device are associated with each other.

4. The device design support method according to claim 3,
wherein in the generation of the integrated design database, the method validates conditions in which the specifications of the device in the device design database correspond to the range of the specifications of the device in the circuit design database.

5. The device design support method according to claim 4,
wherein the sensor is an acceleration sensor of a MEMS device.

6. A device design support apparatus comprising:
a circuit design database in which the circuit configuration configuring a sensor, the range of the specifications of the device configuring the sensor, and the specifications of the sensor are associated with each other;
a device design database in which the specifications of the device and the structure of the device are associated with each other;
an integrated design database that is generated by combining the circuit design database with the device design database;
an input unit for receiving an input of the specifications of the sensor; and
an extraction unit for extracting the circuit configuration and device structure corresponding to the sensor specifications received by the input unit, by referring to the integrated design database.

7. The device design support apparatus according to claim 6,
wherein in the generation of the integrated design database, the method validates conditions in which the specifications of the device in the device design database correspond to the range of the specifications of the device in the circuit design database.

8. The device design support apparatus according to claim 7,
wherein the sensor is an acceleration sensor of a MEMS device.
